(19) United States
(12) Patent Application Publication
(10) Pub. No.: US 2013/0173212 A1
(43) Pub. Date: Jul. 4, 2013

(54) MOTION ANALYSIS METHOD AND MOTION ANALYSIS APPARATUS

(71) Applicant: Seiko Epson Corporation, Tokyo (JP)

(72) Inventors: Kenji SAIKI, Suwa (JP); Masatoshi SATO, Hashima (JP)

(73) Assignee: SEIKO EPSON CORPORATION, Tokyo (JP)

(21) Appl. No.: 13/709,563

(22) Filed: Dec. 10, 2012

(30) Foreign Application Priority Data
Dec. 16, 2011 (JP) 2011-275958

(51) Int. Cl. G01P 13/00

(52) U.S. Cl. CPC G01P 13/00
USPC 702/150

(57) ABSTRACT

A motion analysis apparatus includes a sensor that is attached to an object and detects a physical value of the object, a holder that holds the object and sets the sensor in a first position, and a motion analyzer that acquires an output from the sensor and analyzes the motion of the object based on the output, the output including first output data from the sensor set in the first position and second output data from the sensor produced after the object is separated from the holder and the sensor is set in at least one known second position.

### BACKGROUND

1. Technical Field

The present invention relates to a motion analysis method, a motion analysis apparatus, and other similar technologies.

2. Related Art

There is a need for an apparatus that analyzes the motion of an object in a variety of fields. Such an apparatus can eventually improve, for example, swing paths of a tennis racket and a golf club and pitching and batting forms in baseball.

Currently, a practical motion analysis apparatus typically operates as follows: Images of a marked object under measurement are continuously captured with an infrared camera or any other suitable device, and the captured continuous images are used to calculate a trajectory of the movement of the mark for motion analysis.

An example of the related art includes JP-A-2004-24488.

The motion analysis apparatus described above, however, is inevitably a large-scale apparatus because an infrared camera for capturing images is required, which causes a handling problem. For example, when it is desired to capture images of tennis exercises at a plurality of angles, it is necessary to move the position of the infrared camera in accordance with a desired imaging angle or change the orientation of a player.

In contrast, there is a recently proposed apparatus for analyzing the motion of an object under measurement to which a small inertia sensor is attached based on output data from the sensor. The proposed apparatus is advantageous because it requires no infrared camera and is hence easy to handle. For example, each of the velocity V(t) and the position p(t) of the object under measurement can be calculated by integrating acceleration a(t) detected by an acceleration sensor with time.

In general, however, an output value from an inertia sensor contains an error as well as a target value to be observed. When data outputted from an acceleration sensor is integrated with time to calculate each of the velocity V(t) and the position p(t) of an object under measurement, an error E(t) is also integrated with time. As a result, errors of the velocity V(t) and the position p(t) sharply increase with time t.

### SUMMARY

An advantage of some aspects of the invention is to provide a motion analysis method and a motion analysis apparatus that provide an analysis result with no accumulated error.

Another advantage of some aspects of the invention is to provide a motion analysis apparatus capable of readily acquiring the timing when measurement for motion analysis starts.

(1) One aspect of the invention relates to a motion analysis method including setting an object to which a sensor is attached in a first position with the sensor held stationary in a holder, acquiring an output from the sensor, the output including known first output data from the sensor produced when the sensor is set in the first position and second output data from the sensor produced after the object is separated from the holder and the sensor is set in at least one known second position, and analyzing motion of the object based on the first output data and the second output data.

According to the one aspect of the invention, the sensor acquires a physical value of the object (such as acceleration and angular velocity), and the motion of the object (such as velocity, position, and angle of rotation) can be computed based on the physical value. In this process, when the sensor attached to the object held in the holder is located in the first position, where the object is stationary, the first output data acquired in the first position (specific position data, velocity and angular velocity are both zero) can be used to initialize the sensor output in the first position and a computation result thereof. When the object separated from the first position is in motion, the sensor output contains an error, which is accumulated by the computation. The error can be eliminated by using second output data acquired in at least one second position, whereby the motion of the object can be analyzed.

(2) In the one aspect of the invention, the at least one known second position may coincide with the first position where the object having been separated from the holder is returned to the holder.

In this case, the motion of the object in the period from the timing when the object held in the holder is moved to the timing when the object is returned to the holder again can be analyzed with the error eliminated. Further, the holder allows the first and second positions to precisely coincide with each other, and the error can be eliminated with no specific pass point through which the object separated from the holder passes.

(3) In the one aspect of the invention, the at least one known second position may be where the sensor is located when the object passes through a known pass point.

Depending on the type of object, a pass point through which the object in motion passes may be identified. For example, when the object is a golf club and a golf ball to be hit is teed up, the teed-up position is considered as an additional point through which the club head passes. The teed-up position, which is assumed to be known, can be used as the second position. It is preferable to use the position of the sensor attached to the object held in the holder as the first and second positions, set at least one pass point as another second position, and use known data acquired at the three points or the three points plus one or more points to further reduce the amount of error.

(4) In the one aspect of the invention, a signal produced when the object is separated from the holder may be acquired and the motion of the object may be analyzed based on the signal.

The acquired signal allows an acquired sensor output to be clearly classified into data acquired when the object is held in the holder and set stationary or the following measured data of interest. Further, the sensor output acquired during the period when the object is held in the holder only needs to be large enough in terms of amount of information to identify the first position, and all the sampled data acquired in the stationary state do not need to be stored, whereby the storage capacity of a storage unit that stores sensor outputs can be reduced. Further, acquiring the time when the object is separated from the holder based on the acquired signal described above allows identification of a start position (time) of data processing, for example, for providing velocity and position information by integrating acceleration data with time. It is conceivable to let an operator of the object, such as a sporting good, know that the measurement starts, for example, with the aid of a start sound, which, however, degrades the degree of freedom in motion of the operator and is harmful, for example, because the operator waits the notification of the start time under tension. In this regard, the present aspect is advantageous because no such a harmful effect is present.

(5) In the one aspect of the invention, a signal produced when the object having been separated from the holder is mounted on the holder may be acquired and the motion of the object may be analyzed based on the signal.

The acquired signal allows an acquired sensor output to be clearly classified into data acquired when the object is held again in the holder and set stationary or the following measured data of interest. Further, the sensor output acquired during the period when the object is held again in the holder only needs to be large enough in terms of amount of information to identify an end point where the object is returned to the holder, and the acquisition period is not necessarily set at an excessively large value. The configuration described above can also reduce the storage capacity of the storage unit that stores sensor outputs.

(6) Another aspect of the invention relates to a motion analysis apparatus including a sensor that is attached to an object and detects a physical value of the object, a holder that holds the object and sets the sensor in a first position, and a motion analyzer that acquires an output from the sensor and analyzes motion of the object based on the output, the output including first output data from the sensor set in the first position and second output data from the sensor produced after the object is separated from the holder and the sensor is set in at least one known second position.

In the another aspect of the invention, the motion analysis method according to the one aspect of the invention can be preferably carried out.

(7) In the another aspect of the invention, the holder may be a charger that charges a secondary battery that is attached to the object and feeds electric power to the sensor. The holder can therefore be also used as a charger, and the secondary battery can be charged during the period when the object is mounted on the charger.

(8) In the another aspect of the invention, at least one of the charger and the object may include a switch that detects whether or not the object is mounted on the charger, and the motion analyzer may acquire a signal produced by the switch when the object is separated from the charger and analyze the motion of the object based on the signal.

The acquired signal allows an acquired sensor output to be clearly classified into data acquired when the object is held in the holder and set stationary or the following measured data of interest.

(9) In the another aspect of the invention, the switch may include a first contact provided in the object and a second contact provided in the charger, and the motion analyzer may acquire a signal produced when the first contact is separated from the second contact and analyze the motion of the object based on the signal. The switch may be a mechanical switch or a contact switch. The latter can simplify the configuration.

(10) In the another aspect of the invention, the first contact and the second contact may also be used as charging contacts. In this way, charging and contact/non-contact detection can both be achieved with no additional contacts.

(11) Still another aspect of the invention relates to a motion analysis apparatus including a sensor that is attached to an object and detects a physical value of the object, a charger that holds the object and charges a secondary battery that is attached to the object and feeds electric power to the sensor, and a motion analyzer that acquires an output from the sensor produced when the object is held by the charger and an output from the sensor produced after the object is separated from the holder and analyzes motion of the object based on the outputs. At least one of the charger and the object includes a switch that detects whether or not the object is mounted on the charger, and the motion analyzer acquires a signal produced by the switch when the object is separated from the charger and analyzes the motion of the object based on the signal.

In the still another aspect of the invention, an acquired sensor output can be clearly classified into data acquired when the object is held in the holder and set stationary or the following measured data of interest. Further, the sensor output acquired during the period when the object is held in the charger only needs to be large enough in terms of amount of information to identify the stationary position, and all the sampled data acquired in the stationary state do not need to be stored, whereby the storage capacity of a storage unit that stores sensor outputs can be reduced. Further, acquiring the time when the object is separated from the charger based on the acquired signal described above allows identification of a start position (time) of data processing, for example, for providing velocity and position information by integrating acceleration data with time. It is conceivable to let an operator of the object, such as a sporting good, know that the measurement starts, for example, with the aid of a start sound, which, however, degrades the degree of freedom in motion of the operator and is harmful, for example, because the operator waits the notification of the start time under tension. In this regard, the present aspect is advantageous because no such a harmful effect is present.

### BRIEF DESCRIPTION OF THE DRAWINGS

The invention will be described with reference to the accompanying drawings, wherein like numbers reference like elements.

FIG. 1 shows an example of a motion path of an object under measurement.

FIGS. 2A and 2B show a charger (holder) and an object (golf club) used in a motion analysis method and a motion analysis apparatus according to an embodiment of the invention.

FIG. 3 is a flowchart showing a motion analysis method according to an embodiment of the invention.

FIG. 4 shows sampling of sensor outputs associated with an object set stationary and the object in motion.

FIG. 5 describes a discrepancy between a motion path of an object (golf club) that starts from and reaches the charger (holder) and computation results of a sensor output.

FIG. 6 describes a discrepancy between an end point of the motion path of the object (golf club) and a computation result of a sensor output represented in the form of orthogonal three-axis coordinate system.

FIG. 7 is a block diagram of a motion analysis apparatus according to an embodiment of the invention.

FIG. 8 is a block diagram showing a sensor section shown in FIG. 7 in detail.

FIG. 9 shows the stand-type charger and the golf club held by the charger shown in FIG. 2B.

FIG. 10 shows a detector that detects a mounted/non mounted state between the charger and the golf club shown in FIG. 9.

FIG. 11 shows the ground-type charger and the golf club held by the charger shown in FIG. 2A.

FIG. 12 shows a detector that detects the mounted/non mounted state between the charger and the golf club shown in FIG. 11.

### DESCRIPTION OF EXEMPLARY EMBODIMENTS

A preferred embodiment of the invention will be described below in detail. The present embodiment, which will be described below, is not intended to unduly limit the contents of the invention set forth in the appended claims, and all the configurations described in the present embodiment are not necessarily essential to the solution of the invention. Further, to enlarge each component to be recognizable in the drawings, the dimension and ratio of the component is not drawn to scale as appropriate.

### 1. Motion Analysis Method

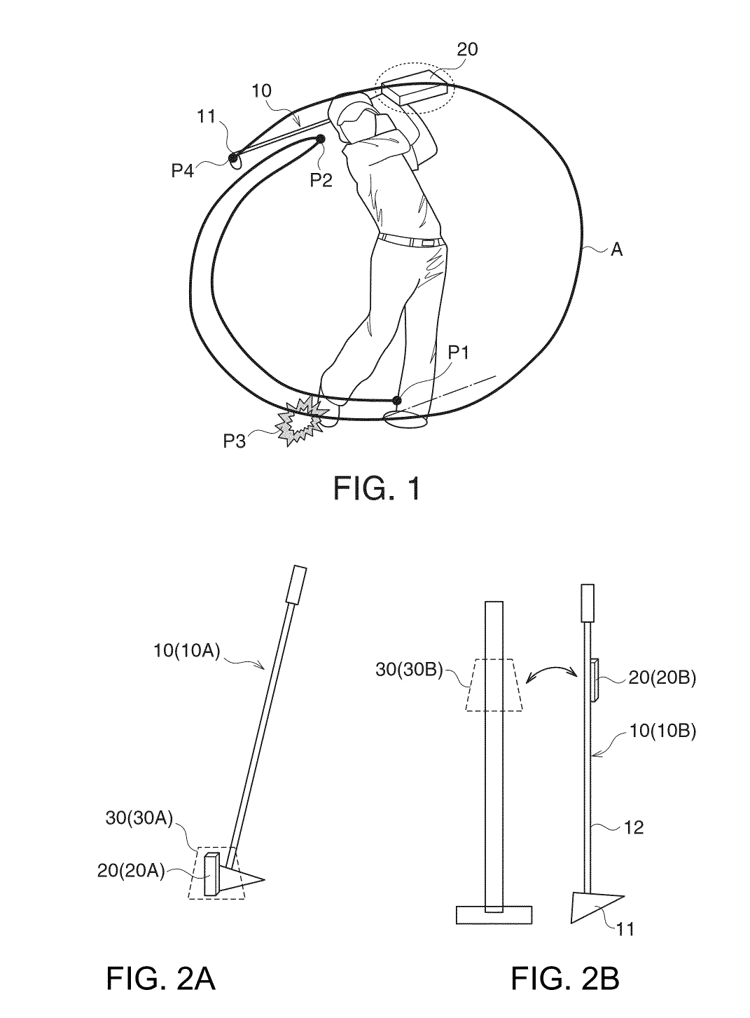

FIG. 1 shows a swing path A of an object under measurement, such as a club head 11 of a golf club 10, which is a sporting good. The swing path A includes a swing initiation position P1, a top position P2, an impact position P3, and a follow through top position P4.

FIGS. 2A and 2B show components used in the present embodiment: the golf club 10 on which a sensor unit 20 (20A, 20B) is mounted; and a holder that holds the golf club 10, for example, a charger 30 (30A, 30B). The charger 30 (30A, 30B) charges a secondary battery that feeds electric power to a sensor built in the sensor unit 20 (20A, 20B).

FIG. 2A diagrammatically shows a golf club 10A with a head sensor unit 20A mounted on the club head 11. A charger 30A, which is of ground type, can hold the club head 11 stationary and charge the secondary battery in the head sensor unit 20A via a contact, which will be described later.

FIG. 2B diagrammatically shows a golf club 10B with a shaft sensor unit 20B mounted on a club shaft 12. A charger 30B, which is of stand type, can hold the club shaft 12 stationary and charge the secondary battery in the shaft sensor unit 20B via a contact, which will be described later.

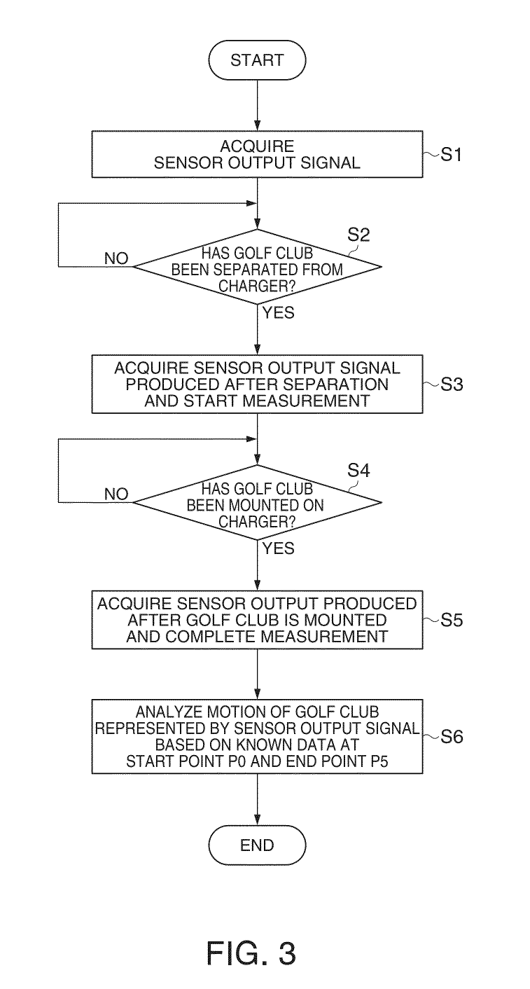

Each of the sensor units 20 shown in FIGS. 2A and 2B accommodates, for example, an acceleration sensor capable of performing three-axis detection. Each of the sensor units 20 can also accommodate an angular velocity sensor capable of performing three-axis detection. A method for analyzing the motion of the golf club 10 by using the sensor unit 20 will be described with reference to FIGS. 3 to 6. The following embodiment relates to a case where the path of the club head 11 on which a sensor is mounted as shown in FIG. 2A is analyzed. Even when the position of the sensor (shaft) differs from the position of the path to be determined (club head) as shown in FIG. 2B, the position of the club head 11, which is set apart by a fixed distance from the sensor position, or any other physical value associated with the club head 11 can be tracked by acquiring the angle of the golf club 10 from the angular velocity sensor and the sensor position from the acceleration sensor.

At the start in FIG. 3, the golf club 10 is mounted on the charger 30 (30A, 30B) shown in FIGS. 2A and 2B and is set stationary. At this point, the sensor unit 20 (20A, 20B) is located in a known start point P0 (first position), and the velocity and the angular velocity are both zero, which are known data at the start point P0 (first position).

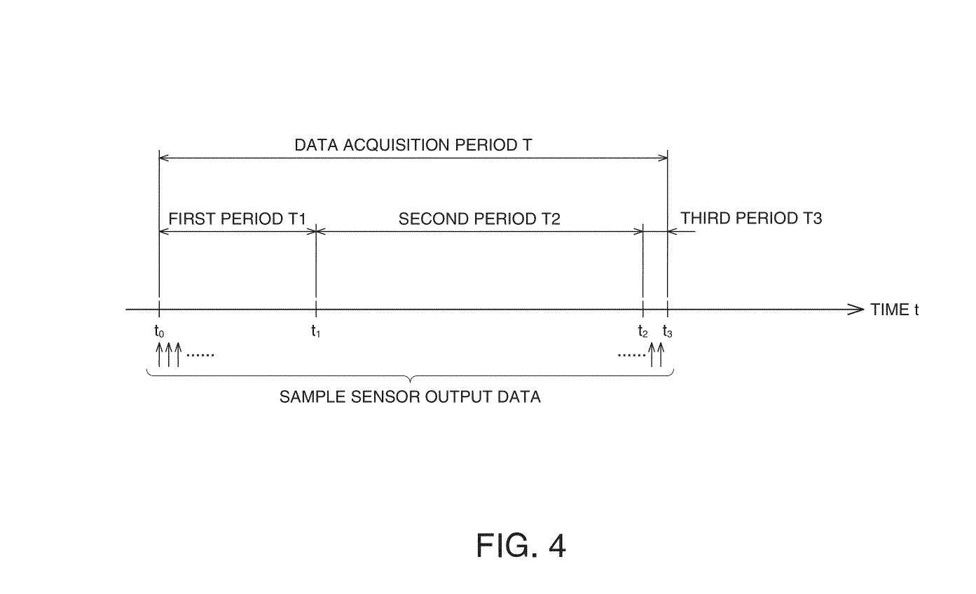

In step S1 in FIG. 3, a sensor output in the stationary state (first output data), in which the golf club 10 is mounted on the charger 30, is acquired. That is, sensor output data in the stationary state starting from start time t0 in FIG. 4 (first output data) are sampled and acquired. In step S2 in FIG. 3, whether or not the golf club 10 has been separated from the charger 30 is monitored. When the fact that the golf club 10 has been separated from the charger 30 is acquired (when it is determined to be YES in step S2 in FIG. 3), the control proceeds to step S3, where a sensor output produced after the golf club 10 is separated from the charger 30 is acquired and measurement for motion analysis starts. That is, sensor output data in the stationary state in a first period T1 from time t0 to t1 in FIG. 4 are sampled, and after the time t1, sensor output data produced after the golf club 10 is separated off the charger 30 are sampled.

In step S4 in FIG. 3, whether or not the golf club 10 has been returned to the charger 30 is monitored. When it is determined to be NO in step S4 in FIG. 3, the measurement in step S3 continues. When the fact that the golf club 10 has been mounted on the charger 30 is acquired (when it is determined to be YES in step S4), a sensor output produced after the golf club 10 is returned to the charger 30 (second output data) is acquired and then the measurement is completed (step S5).

That is, sensor output data produced after the golf club 10 is separated from the charger 30 are sampled in a second period T2 from time t1 to t2 in FIG. 4, and sensor output data produced after the golf club 10 is returned to the charger 30 (second output data) are sampled in a third period T3 from time t2 to t3.

After step S5 in FIG. 3, the control proceeds to step S6, where motion analysis is performed. It is, however, noted that the motion analysis in step S6 may be performed concurrently with the acquisition of a sensor output.

The time t1 shown in FIG. 4 can be automatically acquired by carrying out step S2 in FIG. 3, whereby an acquired sensor output can be clearly classified into the data acquired when the object is held in the holder and set stationary or the following measured data of interest.

Further, the sensor output in the first period T1 (t0 to t1) (first output data) shown in FIG. 4 only needs to be large enough in terms of amount of information to identify the start point P0, and all the sampled data acquired in the first period T1 do not need to be stored. To identify the start point P0, one sampled data or a plurality of sampled data for averaging may be stored, whereby the storage capacity of a storage unit that stores sensor outputs can be reduced. Further, acquiring the time t1 allows identification of a start position (time) of data processing, for example, for providing velocity and position information by integrating acceleration data with time. It is conceivable to let an operator of a sporting good know that the measurement starts, for example, with the aid of a start sound, which, however, degrades the degree of freedom in motion of the operator and is harmful, for example, because the operator waits the notification of the start time under tension. In this regard, the present embodiment is advantageous because no such a harmful effect is present.

Similarly, the time t2 shown in FIG. 4 can be automatically acquired by carrying out step S4 in FIG. 3, whereby an acquired sensor output can be clearly classified into the data acquired when the object is held in the holder again and set stationary (second output data) or the preceding measured data of interest. Further, the sensor output in the third period T3 (t2 to t3) shown in FIG. 4 (first output data) only needs to be large enough in terms of amount of information to identify an end point where the golf club 10 is returned to the charger 30, and the third period T3 is not necessarily set at an excessively large value. The configuration described above can also reduce the storage capacity of the storage unit that stores sensor outputs.

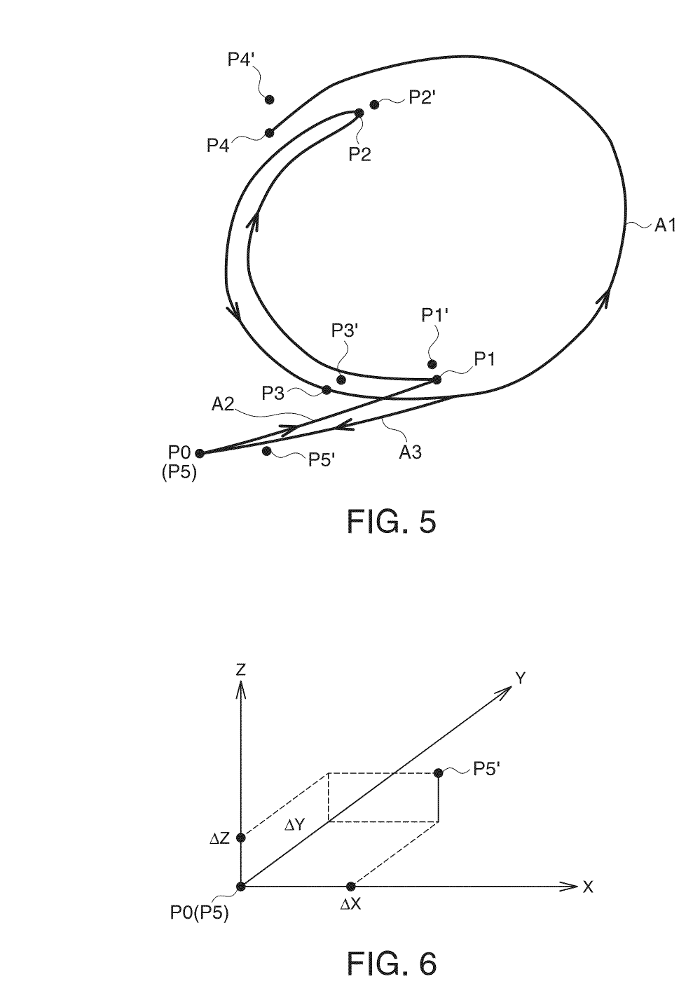

FIG. 5 diagrammatically shows an example of a swing path Al under the condition that the position of the charger 30 (30A, 30B) coincides with the start point P0 and an endpoint P5. The path A1 shown in FIG. 5 is formed of the swing path A shown in FIG. 1 and the following two additional paths: a path A2 that starts from the start point P0 and reaches the swing initiation position P1; and a path A3 that starts from the follow through top position P4, follows, for example, part of the swing path A shown in FIG. 1 as a return path, and then bifurcates and reaches the endpoint P5. In actual measurement, the positions and paths other than the start point P0 and the end point P5 vary.

Each of the velocity V(t) and the position p(t) of, for example, the club head 11 of the golf club 10, which is an object under measurement, can be calculated by integrating acceleration a (t) detected by the acceleration sensor with time, as described above.

In this process, the sensor unit 20 (20A, 20B) is located at the known start point P0 (first position), and the velocity and the angular velocity are both zero. The known data obtained at the start point P0 (first position) are used to initialize the sensor output at the start point P0 (first position) (first output data) and computation results thereof.

Each of actual output data X(t), Y(t), and Z(t) from the acceleration sensor in the sensor unit 20 moving along the path Al shown in FIG. 5, however, contains an error E(t). The error E(t) affects the position p(t) derived by integrating the output data X(t), Y(t), and Z(t) from the acceleration sensor in the sensor unit 20 with time twice. That is, although the actual and computed positions p(t) at the start point P0 are so initialized that they coincide with each other, actual positions P1 to P5 shown in FIG. 5 do not coincide with computed positions P1′ to P5′.

On the other hand, the position of the object under measurement at the end point (second position) P5 is also known, and the velocity and the angular velocity at the end point P5 are both zero (known). The known data acquired at the end point (second position) P5 can be used to make correction for eliminating an accumulated error resulting from the time integration of the error E(t) contained in each of the output data X(t), Y(t), and Z(t).

FIG. 6 shows errors ΔX, ΔY, and ΔZ of the X, Y, and Z components along the orthogonal three axes between the end point P5 (=P0), which is acquired when no error is present, and an end point P5′ computed based on the output data X(t), Y(t), and Z(t), which are second output data from the sensor located at the end point P5. In FIG. 6, the end point P5 (=P0) is initialized to have X=0, Y=0, and Z=0. The golf club 10 having started from the start point P0 at the time t1 reaches the end point P5 at the time t2, as shown in FIG. 4. In the path A1 of the golf club 10 shown in FIG. 5, the error components in the X, Y, and Z directions per unit time Δt are therefore ΔX/(t2−t1), ΔY/(t2−t1), and ΔZ/(t2−t1).

That is, the error components ΔX/(t2−t1), ΔY/(t2−t1), and ΔZ/(t2−t1) in the X, Y, and Z directions accumulate whenever the unit time Δt elapses. Assuming, for example, that the object under measurement starts from the position P0 and reaches the position P1′ in n×Δt, the correct position P1 can be determined by multiplying the errors ΔX/(t2−t1), ΔY/(t2−t1), and ΔZ/(t2−t1) in the X, Y, and Z directions by n and subtracting the resultant accumulated errors from the X, Y, and Z components acquired in the position P1′. Similarly, the positions P2′ to P5′ computed based on the output data X(t), Y(t), and Z(t) from the sensor can be corrected to the correct positions P2 to P5. It is, however, noted that a method for correcting a computation result of a sensor output by using known data acquired in the known positions P0 and P5 is not limited to the method described above.

In the embodiment described above, which relates to analysis of the position of the golf club 10, the velocity V (t) obtained by integrating output data from the sensor with time only once can be similarly corrected by using known data, that is, velocities in the first position P1 and the second position P5 are zero. Output data from the angular velocity sensor can be similarly corrected by using known data on the angle of rotation around each axis in the first position P1 and the second position P5.

In the embodiment described above, the first position P1 and the second position P5 coincide with each other, but they do not necessarily coincide with each other. The second position may be the position of the sensor located when the object passes through a known pass point. For example, since the impact position P3 shown in FIGS. 3 and 5 is a known position where a golf ball is teed up, the impact position P3 can be used as at least one second position. Known data acquired in the first position P1 and the two second positions P3 and P5 can be preferably used to analyze the motion of the golf club 10.

### 2. Motion Analysis Apparatus

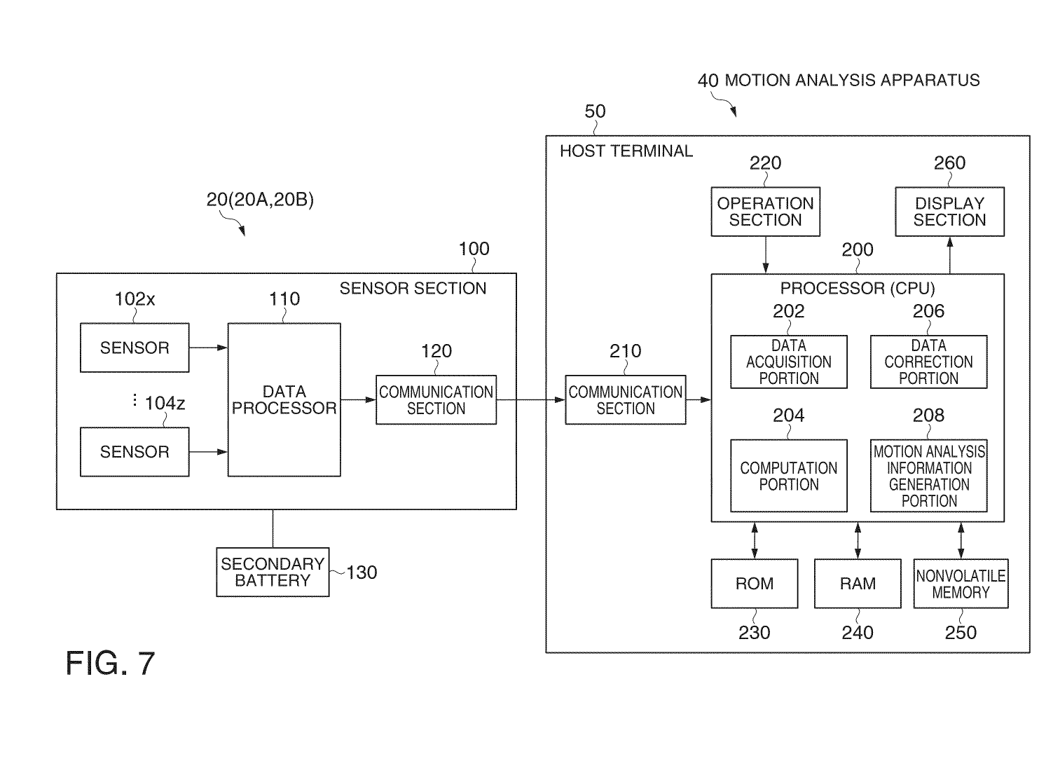

FIG. 7 shows the configuration of a motion analysis apparatus according to the present embodiment. A motion analysis apparatus 40 according to the present embodiment includes one or more sensor units 20 and a host terminal 50 and analyzes the motion of an object of interest 10. Each of the sensor units 20 can be formed of a sensor section 100 and a secondary battery 130. The sensor section 100 and the host terminal 50 maybe wirelessly connected or wired to each other.

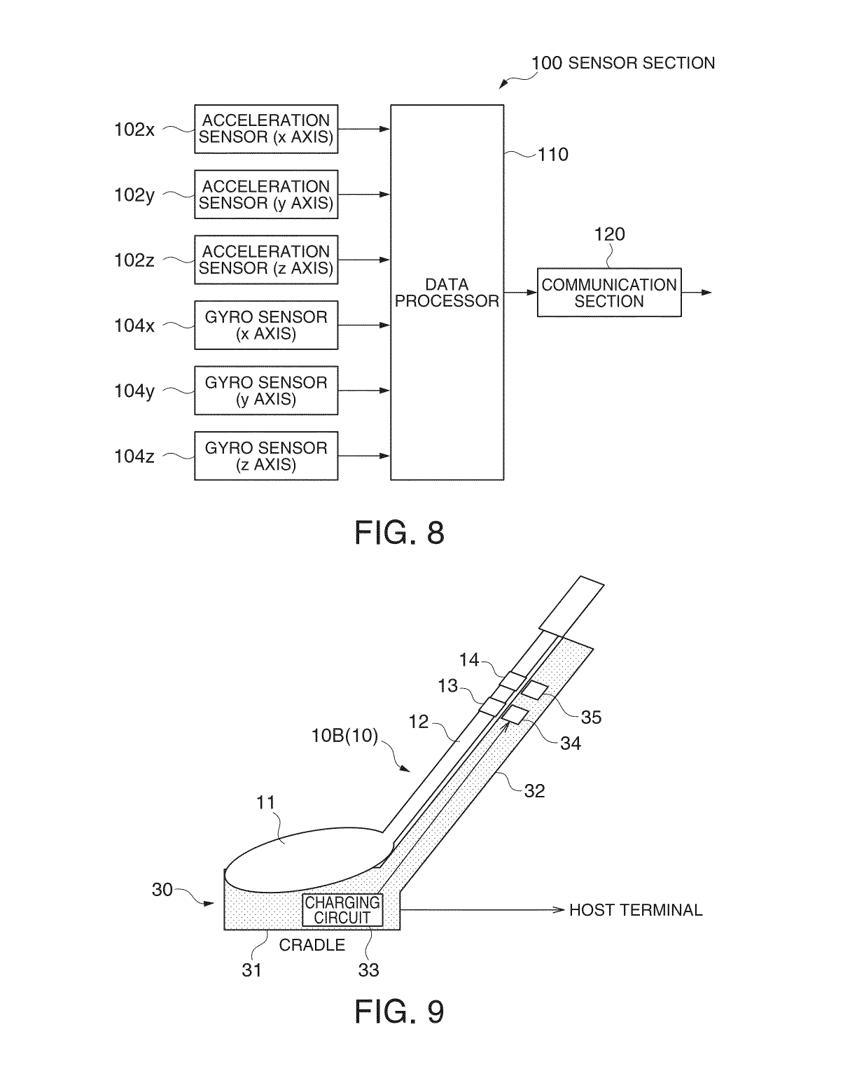

The sensor unit 20 is attached to the object 10 under motion analysis as shown in FIG. 2A or 2B and detects a predetermined physical value. In the present embodiment, the sensor section 100 includes at least one sensor, for example, a plurality of sensors 102x to 102z and 104x to 104z, a data processor 110, and a communication section 120, as shown in FIG. 8.

Each of the sensors detects a predetermined physical value and outputs a signal (data) according to the magnitude of the detected physical value (acceleration, angular velocity, velocity, and angular acceleration, for example). In the present embodiment, a six-axis motion sensor formed of the following sensors is provided: three-axis acceleration sensors 102x to 102z (example of inertia sensor) each of which detects acceleration values in the X-axis, Y-axis, and Z-axis directions; and three-axis gyro sensors 104x to 104z (example of angular velocity sensor, inertia sensor) each of which detects angular velocity values in the X-axis, Y-axis, and Z-axis directions.

The data processor 110 synchronizes output data from the sensors 102x to 102z and 104x to 104z with each other, combines the data, for example, with time information to form packets, and outputs the packets to the communication section 120. The data processor 110 may be configured to further perform bias correction and temperature correction on the sensors 102x to 102z and 104x to 104z. The functions of bias correction and temperature correction may alternatively be incorporated in the sensors themselves.

The communication unit 120 transmits the packet data received from the data processor 110 to the host terminal 50.

The host terminal 50 includes a processor (CPU) 200, a communication section 210, an operation section 220, a ROM 230, a RAM 240, a nonvolatile memory 250, and a display section 260.

The communication section 210 receives data transmitted from the sensor section 100 and forwards the data to the processor 200.

The operation section 220 acquires operation data from a user and forwards the data to the processor 200. The operation section 220 is formed, for example, of a touch panel display, buttons, keys, and a microphone.

The ROM 230 stores a program that instructs the processor 200 to carry out a variety of computation and control processes, a variety of programs and data for providing application functions, and other information.

The RAM 240 is a storage section that is used as a work area by the processor 200 and temporarily stores programs and data read from the ROM 230, data inputted through the operation section 220, computation results produced by the processor 200 in accordance with a variety of programs, and other information.

In the present embodiment, in particular, known data acquired in the first position P0 and the second positions P3 and P5 can be stored in the ROM 230 or the RAM 240.

The nonvolatile memory 250 is a storage section that stores part of the data produced in processes carried out by the processor 200, specifically, data required to be saved for a long period.

The display section 260 displays results produced in processes carried out by the processor 200 in the form of character, graph, or any other image. The display section 260 is formed, for example, of a CRT, an LCD, a touch panel display, or an HMD (head mounted display). A single touch panel display may alternatively function as both the operation section 220 and the display section 260.

The processor 200 performs various types of calculation on data received from the sensor section 100 via the communication section 210 and various types of control (such as display control on display section 260) in accordance with the programs stored in the ROM 230.

In the present embodiment, in particular, the processor 200 functions as a data acquisition portion 202, a computation portion 204, a data correction portion 206, and a motion analysis information generation portion 208.

The data acquisition portion 202 acquires data outputted from the sensor section 100 in a period including the first and third period T1, T3 in FIG. 4, where a physical value of the object 10 detected by the sensors 102x to 102z and 104x to 104z undergoes m-th-order time integration (m is a natural number) to provide known true values, and the second period T2, which provides data that undergo motion analysis. The acquired data are stored, for example, in the RAM 240.

The computation portion 204 performs initialization by using known data acquired in the position P0 in the first period T1 in FIG. 4 and m-th-order time integration on output data from the sensor section 100. When the computation portion 204 performs, for example, second-order time integration on output data from the sensor section 100, the positions P0 and P1′ to P5′ shown in FIG. 5 are derived.

The data correction section 206 corrects computation results from the computation portion 204 based on known data acquired in the position P5 in the third period T3 in FIG. 4, whereby the positions P1′ to P5′ shown in FIG. 5 are corrected to the correct positions P1 to P5.

The motion analysis information generation portion 208 generates information used to analyze the motion of the object of interest 10 (hereinafter referred to as “motion analysis information”) based on the corrected data from the data correction portion 206. The generated motion analysis information may be displayed on the display section 260 in the form of character, graph, figure, or any other object or may be outputted to a component external to the host terminal 50. Each of the computation portion 204, the data correction portion 206, and the motion analysis information generation portion 208 is an example of a motion analyzer.

### 3. Charger and Sporting Good

A description will next be made of the charger 30 and the sporting good 10 under measurement preferably used in the motion analysis method and the motion analysis apparatus according to the present embodiment.

FIG. 9 shows an example of a basic configuration of the charger 30 and a sporting good (golf club) 10B under measurement shown in FIG. 2B. The charger 30, which functions as a holder, includes a ground portion 31, a shaft holding portion 32 that extends upward from the ground portion 31, a charging circuit 33 provided, for example, in the ground portion 31, and two charging terminals 34 and 35 provided in the shaft holding portion 32. The golf club 10B has charged terminals 13 and 14, which come into contact with the charging terminals 34 and 35 of the charger 30, provided in the club shaft 12. The sensor unit 20 provided on the golf club 10B is not shown in FIG. 9.

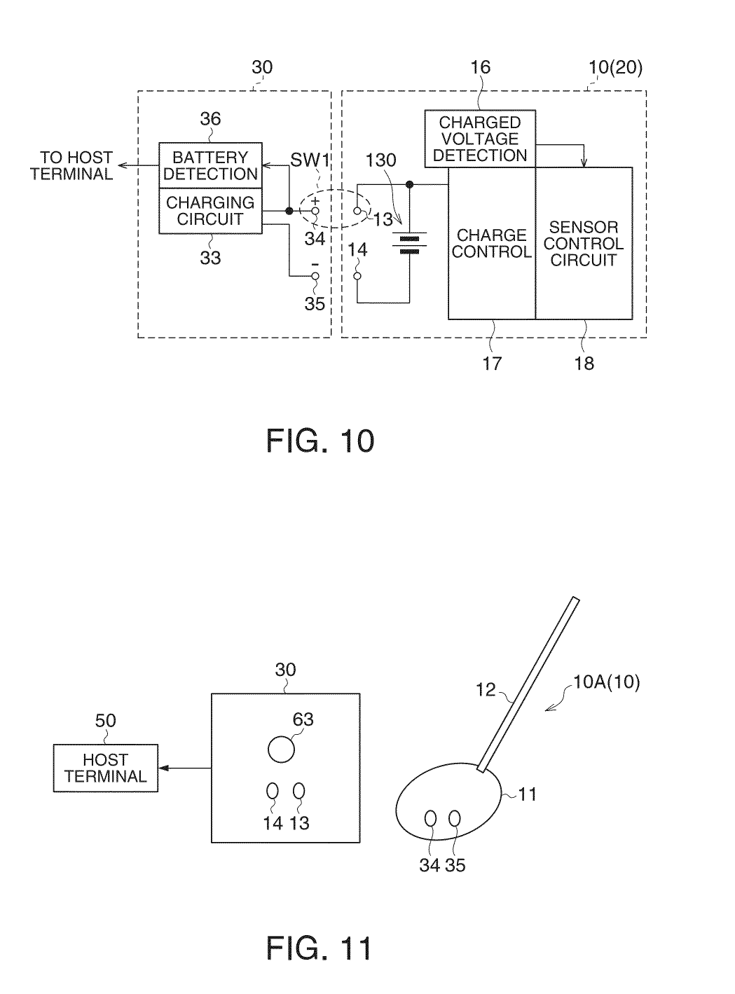

FIG. 10 shows an example of a configuration in which the golf club 10B and the charger 30 shown in FIG. 9 are used to detect whether or not the golf club 10B is mounted on the charger 30 in steps S2 and S4 in FIG. 3.

The sensor unit 20 attached to the golf club 10B accommodates the secondary battery 130 connected to charged terminals 13 and 14. The sensor unit 20 can be provided with a charged voltage detection circuit 16, a charge control circuit 17, a sensor control circuit 18 and other circuits as well as the components shown in FIG. 7. The charged voltage detection circuit 16 detects the charged voltage of the secondary battery 130, and the charge control circuit 17 controls charging of the secondary battery 130 based on the detection result. The sensor control circuit 18 receives electric power from the secondary battery 130 and controls the sensors 102x to 102z and 104x to 104z shown in FIG. 7. On the other hand, the charger 30 can be provided with a battery detection circuit 36 connected, for example, to the charging terminal 34, which is the positive terminal.

The charger 30 and the golf club 10B include a switch SW1, which detects whether or not the golf club 10B is mounted on the charger 30 and can be formed, for example, of the charged terminal 13 (first contact) provided in the golf club 10B and the charging terminal 34 (second contact) provided in the charger 30.

Whether or not the charged terminal 13 (first contact) and the charging terminal 34 (second contact) come into contact with each other is detected, for example, by the battery detection circuit 36 provided in the charger 30. The battery detection circuit 36 can determine whether or not the secondary battery 130 is connected based on the current, voltage, resistance, or any other parameter that varies in accordance with whether or not the charged terminal 13 (first contact) and the charging terminal 34 (second contact) come into contact with each other. The switch SW1 and the battery detection circuit 36 are examples of a mounted/not mounted state detector.

That is, the output from the battery detection circuit 36 is information representing whether or not the golf club 10B is mounted. When the host terminal 50 shown in FIG. 7 acquires the information, whether or not the golf club 10B has been mounted on the charger 30 can be detected in steps S2 and S4 in FIG. 3. The motion analyzers 204, 206, and 208 shown in FIG. 7 can therefore analyze the motion of the golf club 10B in response to a signal produced when the first contact 13 is separated from the second contact 34 and a signal produced when the first contact 13 then comes into contact with the second contact 34.

The mounted/not mounted state detection signals may be transmitted as data along with a sensor output to the host terminal 50 or may be transmitted separately from a sensor output to the host terminal 50 in a wired or wireless manner.

Alternatively, the battery detection circuit 36 shown in FIG. 10 may be provided on the side where the golf club 10B is present, and a mounted/not mounted state detection signal may be wirelessly transmitted from the side where the golf club 10B is present to the host terminal 50. The mounted/not mounted state detection scheme shown in FIG. 10 is also applicable to the golf club 10A shown in FIG. 2A.

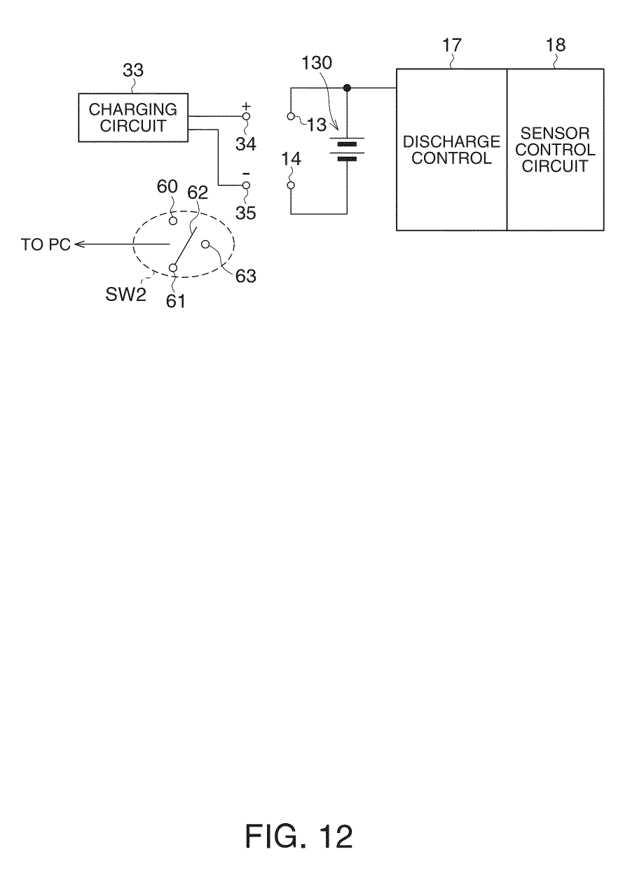

FIGS. 11 and 12 show a mounted/not mounted state detection scheme different from that shown in FIG. 10, and applicable, for example, to the golf club 10A shown in FIG. 2A. A protruding push button 63 is formed in a position where the charger 30 holds the club head 11, as shown in FIG. 11. The push button 63 is pressed when the club head 11 is mounted on the charger 30.

The charger 30 is provided with a switch SW2 including the push button 63 in addition to the charging terminals 34 and 35, as shown in FIG. 12. The switch SW2 includes two fixed contacts 60 and 61 and a movable contact 62 that short-circuits the fixed contacts 60 and 61 when the push button 63 is pressed.

The output from the switch SW2 can be changed in accordance with the state of the switch SW2, a closed state (mounted state) and an open state (non-mounted state). The signal from the switch SW2 can therefore be used as the mounted/not mounted state detection signal. In this case as well, the mounted/not mounted state detection signal may be transmitted as data along with a sensor output to the host terminal 50 or may be transmitted separately from a sensor output to the host terminal 50 in a wired or wireless manner.

The present embodiment has been described in detail, and the skilled in the art may readily understand that a large number of variations that do not substantially depart from the new features and advantageous effects of the invention can be implemented. It is intended that all the variations fall within the scope of the invention. For example, an object under measurement in the invention can preferably be a golf club, a tennis racket, and other sporting goods but is not limited thereto.

The entire disclosure of Japanese Patent Application No. 2011-275958, filed Dec. 16, 2011 is expressly incorporated by reference herein.

What is claimed is:

1. A motion analysis method comprising:
setting an object to which a sensor is attached in a first position with the sensor held stationary in a holder;
acquiring an output from the sensor, the output including known first output data from the sensor produced when the sensor is set in the first position and second output data from the sensor produced after the object is separated from the holder and the sensor is set in at least one known second position; and
analyzing motion of the object based on the first output data and the second output data.

2. The motion analysis method according to claim 1,
wherein the at least one known second position coincides with the first position where the object having been separated from the holder is returned to the holder.

3. The motion analysis method according to claim 1,
wherein the at least one known second position is where the sensor is located when the object passes through a known pass point.

4. The motion analysis method according to claim 1,
wherein a signal produced when the object is separated from the holder is acquired and the motion of the object is analyzed based on the signal.

5. The motion analysis method according to claim 2,
wherein a signal produced when the object having been separated from the holder is mounted on the holder is acquired and the motion of the object is analyzed based on the signal.

6. A motion analysis apparatus comprising:
a sensor that is attached to an object and detects a physical value of the object;
a holder that holds the object and sets the sensor in a first position; and
a motion analyzer that acquires an output from the sensor and analyzes motion of the object based on the output, the output including first output data from the sensor set in the first position and second output data from the sensor produced after the object is separated from the holder and the sensor is set in at least one known second position.

7. The motion analysis apparatus according to claim 6,
wherein the holder is a charger that charges a secondary battery that is attached to the object and feeds electric power to the sensor.

8. The motion analysis apparatus according to claim 7,
wherein at least one of the charger and the object includes a switch that detects whether or not the object is mounted on the charger, and
the motion analyzer acquires a signal produced by the switch when the object is separated from the charger and analyzes the motion of the object based on the signal.

9. The motion analysis apparatus according to claim 8,
wherein the switch includes a first contact provided in the object and a second contact provided in the charger, and
the motion analyzer acquires a signal produced when the first contact is separated from the second contact and analyzes the motion of the object based on the signal.

10. The motion analysis apparatus according to claim 9,
wherein the first contact and the second contact are also used as charging contacts.

11. A motion analysis apparatus comprising:
a sensor that is attached to an object and detects a physical value of the object;
a charger that holds the object and charges a secondary battery that is attached to the object and feeds electric power to the sensor; and
a motion analyzer that acquires an output from the sensor produced when the object is held by the charger and an output from the sensor produced after the object is separated from the holder and analyzes motion of the object based on the outputs,
wherein at least one of the charger and the object includes a switch that detects whether or not the object is mounted on the charger, and
the motion analyzer acquires a signal produced by the switch when the object is separated from the charger and analyzes the motion of the object based on the signal.
